(19) United States
(12) Patent Application Publication
(10) Pub. No.: US 2010/0176573 A1
(43) Pub. Date: Jul. 15, 2010

(54) Muffler insulator for motorcycles

(76) Inventors: Darrick Corneiius Melton, Joliet, IL (US); Amy Louise Melton, Joliet, IL (US)

Correspondence Address: Darrick and Amy Melton, 1016 Mission Blvd., Joliet, IL, 60436, US

(21) Appl. No.: 12/655,412

(22) Filed: Dec. 29, 2009

Related U.S. Application Data
(60) Provisional application No. 61/203,946, filed on Dec. 31, 2008.

(51) Int. Cl. B62J 27/00

(52) U.S. Cl. 280/304.3

(57) ABSTRACT

One embodiment of an insulator for motorcycle mufflers which consists of flexible material which withstands high temperatures (approximate maximum of 2000 degrees), and is attached to material which makes up the exterior part of the product. The inner material, which withstands the high temperatures, absorbs heat. In addition to the heat absorption, by attaching the tubing to the inner material, air flow takes place, significantly reducing the heat radiating from the exhaust. Not only does the device protect motorcycle riders from burns, it also protects the muffler from debris, while containing an aesthetically pleasing exterior.

### CROSS-REFERENCE TO RELATED APPLICATIONS

This application claims the benefit of provisional patent application No. 61/203,946, filed 2008 Dec. 31 by the present authors.

### FEDERALLY SPONSORED RESEARCH

Not Applicable

### SEQUENCE LISTING OR PROGRAM

Not Applicable

### BACKGROUND

### Field

This application relates to motorcycles, specifically to protection from heat emitted by motorcycle exhaust pipes.

### BACKGROUND

### Prior Art

Motorcycle exhaust pipes become dangerously hot after the motorcycle has been running for some time, thus causing a risk for severe burns to a motorcycle rider, as well as a non-rider who comes into close contact with the muffler. Until now, in order to prevent him or herself from these burns would have to rely on one of two methods. First, wear clothing and/or foot ware. In my experience however, many riders prefer to wear clothing and/or shoes, such as shorts or sandals, particularly in warm weather. Furthermore, the hot muffler remains exposed for a non-rider to come into contact with it.

Secondly, various mechanisms have been proposed for allowing, natural air flow, which would thereby deflect hot air from the exhaust pipe. The problem with these products is that they do not provide adequate protection to a rider from burns, nor do they offer the flexibility that this application does.

For instance, U.S. Pat. No. 5,036,947 to Jeffrey S. Metzger on (1991), is a metal shield which is used as an attachment to a motorcycle exhaust pipe, by using “spacers” for securing the shield to the exhaust pipe. This device works as an “air coolant” in order to keep heat away from contact with the rider.

However, this device is dependent on air flow to operate as a heat shield. Therefore, if there is no air flow, there is no cooling process. If the motorcycle stops moving, the exhaust pipe gets hotter, without any heat absorption. It does not provide adequate protection to rider from heat. Furthermore, the use of this object is limited to motorcycles which are equipped with circular shaped exhaust pipes, while, in my experience, many if not most, motorcycle exhaust pipes are elliptical shaped, particularly those for high-powered sports bikes.

Similarly, various applicants have proposed heat shield products as a means to protect riders from the heat of the exhaust pipe. These would include, in addition to Metzger's Patent: U.S. Pat. Nos. 7,556,292 to Patrick F. King (2009), 6,179,313 to Daniel C. Christensen (2001), 4,955,193 to Herbert W. Hoeptner III (1990), 6,854,542 B2 (2005), 3,756,623 to Larry Dale Whittler, and U.S. Patent Application no. 20040045756 to James Martin (2004).

However, these products, although they provide some type of protection from heat by deflecting heat, they all suffer from a number of disadvantages and ultimately do not provide adequate protection to a rider from burns.
(a) They all depend on air flow to deflect, rather than absorb, heat. Air flow occurs only when the motorcycle is actually, moving. The space between the rider's leg and the muffler cools when the motorcycle moves at a fast enough speed for the process to occur, and therefore heat is deflected. Nevertheless, if the motorcycle does not move at a sufficient speed for this to happen, then there is no heat barrier and no protection to the rider from burns.
(b) They do not act as heat insulators, In other words, those devices do not wrap around the muffler, but are made with hard materials such as metal or plastic, which are attached to the exhaust pipe. The muffler remains fully exposed to a rider's leg, and therefore, providing harmful exposure. For example, U.S. Pat. No. 6,179,313 embodies a device which is a foot rest and is attached to the exhaust pipe, not the muffler, and consequently, a rider may still get burned, especially if the rider does not actually use the foot rest.
(c) The hard materials from which the proposed devices are constructed, that is, for example, plastic and/or metal, are not pliable and their use is therefore limited. For instance, although U.S. Patent Application 20040045756 has been offered as a heat shield between the exhaust pipe and leg, its proposed materials are hard and inflexible. Also, this product, as U.S. Pat. No. 5,036,947, which is made of metal, are limited to use on circular pipes, and not pipes of other shapes. Although exhaust pipes on sports bikes come in a variety of shapes and sizes, my experience shows that many, if not most, are elliptical shaped,
(d) The Techmat exhaust blanket, which I discovered via the Internet, provides heat insulation but comes directly in contact with the muffler, without the benefit of air flow. Also, it operates as a “sound absorber, but many sports bike enthusiasts prefer to avoid sound reduction of their mufflers. This product does not offer aesthetic advantages.
(e) U.S. Pat. No. 3,756,623 as previously cited, embodies a “heat shield” to protect a motorcycle passenger. However, its purpose is to limit exposure to the exhaust emitted from the motorcycle. It does not offer protection from the hot surface of the pipe itself in the event a rider's skin comes into direct contact with it.
(f) Items which are available on the market and which are made from metal, such as steel, may provide air flow but lack adequate heat absorption and therefore inadequate protection to a rider.
(g) They do not provide adequate protection to the muffler/pipe itself. The repair and/or replacement cost of a motorcycle muffler can be very costly. The aforesaid Patents fail to protect the muffler from the “nicks and dents” caused by debris.

### SUMMARY

Our product is installed as a kit product for easy installation and use, provides not just a means to reduce exhaust heat by providing air flow, but also absorbs heat, for mufflers of a variety of shapes and sizes, not just circular shaped mufflers. It is intended to be used on mufflers with an approximate maximum length of twenty-two inches (22″) and circumferences of approximate maximum of eighteen inches (18″), and will also act as a shield against loose stones and debris, which could damage a muffler.

### DRAWINGS

### Figures

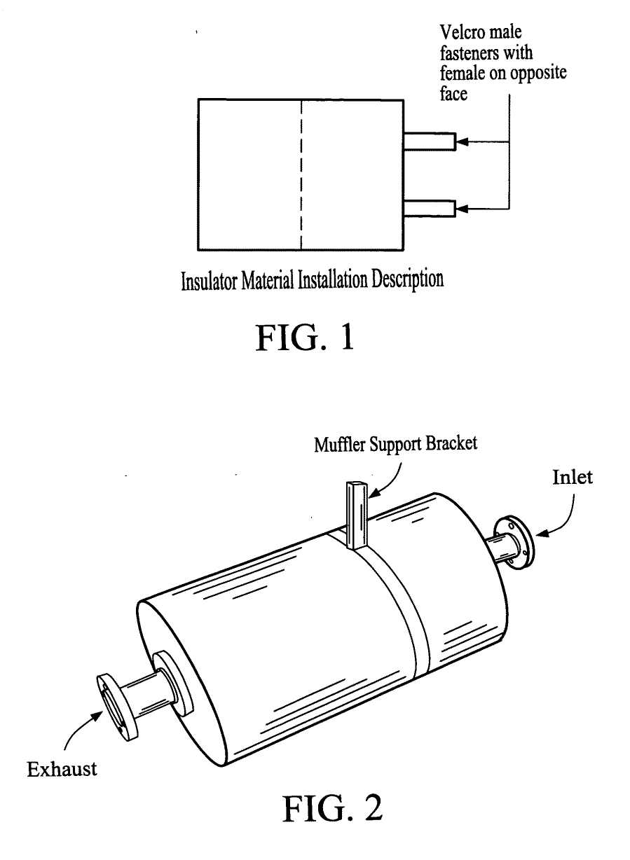

FIG. 1 is a description of the “muffler insulator” installation with a drawing of the device while lying flat, the interior material face up, with measurements and directions for installation.

FIG. 2 shows a view of a motorcycle muffler without the insulator attached.

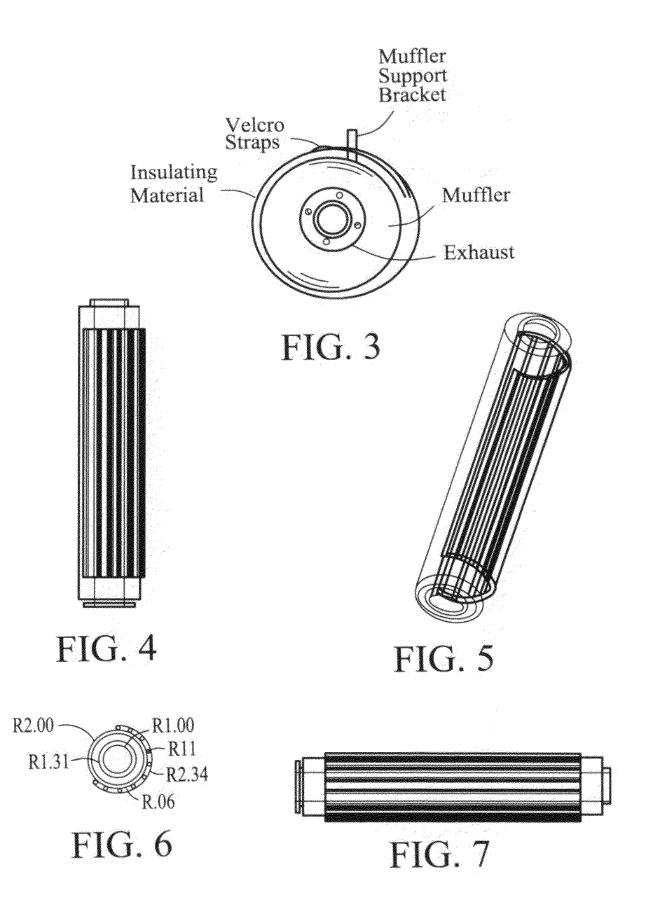

FIG. 3 is an end view of the “muffler insulator” installation.

FIG. 4 is an exterior view of the length of a muffler with the “muffler insulator” attached, with measurements.

FIG. 5 is a view of the muffler, with “muffler insulator”, which shows its application to that part of the muffler which faces away from the motorcycle.

FIG. 6 shows an end view of the muffler, with the “muffler insulator” attached.

FIG. 7 shows a horizontal view of the muffler, with the “muffler insulator” attached and measurements.

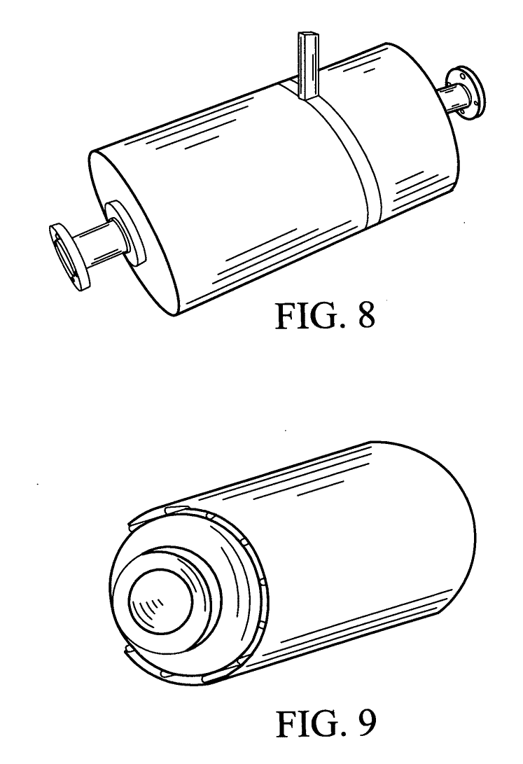

FIG. 8 is a duplicate of FIG. 2.

FIG. 9 shows an alternative view of the muffler, with “muffler insulator” attached.

### DRAWINGS

### Reference Numerals

R06 Posterior view of row
R1.00 Posterior view of inner layer of exhaust pipe
R1.31 Posterior view of outer layer of exhaust pipe
R2.00 Posterior view of outer exterior of muffler
R2.34 Posterior view of exterior side of muffler insulator
R11 Posterior view of interior of insulating material

### DETAILED DESCRIPTION

### FIGS. 1 and 2

The embodiment of the “muffler insulator” is shown in FIGS. 1 and 2. As shown in FIG. 2, the motorcycle muffler itself has an approximate maximum length of 22 inches and approximate maximum circumference of 18 inches. Its components consist of an “inlet” (FIGS. 2 and 8) which attaches to the part of the motorcycle where exhaust is emitted to the exhaust pipe. The muffler encloses the exhaust pipe and the end of the pipe extends outward, opposite of the “inlet” and away from the motorcycle, facing the rear wheel.

A “muffler support bracket” attaches the muffler to the motorcycle itself.

FIG. 1 is the “muffler insulator” itself, laid out flat, interior insulating material face up. It is approximately a maximum of 22″ in length, 26″ wide, and 0.108″ thick. The final insulating configuration, with the insulating material, has an approximate thickness of 0.126″ on the top and outer surface, where a rider could come into inadvertent contact with a hot muffler, thereby causing burns.

FIG. 1 explains how the “muffler insulator” is to be installed, and FIG. 3 shows a posterior view of the muffler with the “muffler insulator.”

### OPERATION

### FIGS. 1-9

As shown in FIG. 1, a “muffler insulator” would be available to a consumer with instructions for installation.

The product user would measure the location of the “muffler support bracket” (FIG. 2) and cut four inches (4″) into the material and one inch (1″) toward the edge (FIG. 1). This is done to accommodate the bracket. The material, which is cut with a household tool, should not be discarded so that the material covers a part of the bracket itself.

Next, the device is placed on the rear of the muffler (the side closest to the motorcycle) with the “muffler support bracket” in the cut slot (FIGS. 1 and 2).

Then the installer wraps the “muffler insulator” around the muffler in a counter-clockwise direction. A second slot is then cut the same way as before to accommodate the bracket.

The Velcro straps (FIG. 1) are secured to keep the device firmly in place. As for the material comprising the “muffler insulator,” the interior is a composite of laminated layers of insulating material and tubing, and the exterior layer of a decorative fabric glued or taped to the insulating material (FIG. 8).

The insulating material is manufactured from flexible woven single continuous filament amorphous silica yarns rated for a contact temperature of 2000 degrees Fahrenheit. This material is available on the market and is not implied as part of this application. FIGS. 3-8.

Furthermore, as shown in FIGS. 4-7 and 9, rows of tubing R06, R11 are attached to the interior of the insulating material, approximately one to two inches (1-2″) apart from each other, extending down the length of the “muffler insulator.” These rows are to provide air flow, thereby reducing heat, and are located between the interior part of the insulating material and the exterior of the muffler. The material used for these rows is available on the market and not implied as part of this patent. R11, R2.00.

In order to prevent any fraying of the insulating material, thermal tape is used, which, like the insulating material, is available on the market and not implied as part of this application. This tape is similar to the insulation material with respect to its thermal conductivity. Due to its relatively low thermal conductivity, the tape will not leave any adhesive residue from high temperatures.

The tape is applied to all four edges of the “muffler insulator,” as shown in FIGS. 4-7.

From the description above, a number of advantages of embodiments of our “muffler insulator” become evident:

(a) The use of the insulating material as described herein which comes into contact with the motorcycle muffler by being wrapped around the muffler and spaced by rows, absorbs heat emitted at high temperatures from the exhaust and protects a rider from burns;

(b) The embodiment includes an outer layer of material which is glued or taped to the insulating material for aesthetic appeal, as well as additional protection;

(c) The embodiment also protects the muffler itself from debris, which would otherwise damage it, and the use of rows of tubing which extend the length of the “muffler insulator” would crush on impact, rather than damage the muffler;

(d) The “muffler insulator” incorporates the use of thermal tape to prevent fraying, thereby ensuring its longevity;

(e) The “muffler insulator” utilizes Velcro straps, which are attached to the outer layer, to allow the device to be secured in place, while easy to remove when not in use;

(f) Because the “muffler insulator” is installed on the muffler by use of household tools to accommodate the “muffler support bracket,” it can easily be customized for different angled exhaust brackets to make it useful on different styles of mufflers.

### Conclusion, Ramifications, and Scope

Therefore, the reader will see that the “muffler insulator” will protect a rider, particularly a passenger, from burns and also save the muffler from damage caused by loose stones and debris. It acts not only as a shield by providing air flow, but also a heat absorber of most of the radiant heat, thereby the muffler, with the device intact, to be warm, not hot, to the touch.

The “muffler insulator” has the additional advantages of:
Being easy to install by requiring only the use of household tools to cut two (2) slots in order to enable the “muffler insulator” to fit around, and attach to, the muffler;
Not only consisting of two layers of insulating material in order to absorb heat and protect against burns, but also including tubing that provides air flow, such as copper or nylon, thereby providing greater protection;
Being constructed with thermal tape to prevent fraying on the edges, thereby ensuring the longevity of the device;
Having an outer layer which provides for additional protection and satisfies the aesthetic tastes of a consumer, and making the “muffler insulator” a physically attractive product;
Using Velcro straps to make the device easy to remove and yet sufficiently secure;
Offering the flexibility of being used on not just circular pipes, but other shapes, such as elliptical pipes, with approximate maximum dimensions of 22″ for length and 18″ for circumference.

We claim:

1. A product to be used on motorcycle mufflers, comprising of:
a. A flexible material manufactured from woven single continuous filament amorphous silica yarns which withstands high temperatures to prevent a motorcycle rider from burns;
A plurality of rows consisting of material which reduces heat flow across the muffler which is emitted from the exhaust pipe, and where each row would extend the length of heat absorbing material. Each row is spaced approximately one to two inches from each other and are interposed between the inner side of the heat absorbing material and the outer layer of the muffler;
c. A mechanism for securing said product to the muffler, and yet is easy to install and remove.

2. The device of claim 1 wherein said material absorbs heat emitted from the motorcycle exhaust.

3. The device of claim 1 wherein said material shields a rider, especially a passenger, from heat emitted from the motorcycle exhaust.

4. The device of claim 1 wherein said material may be attached to additional fabric which surrounds said material, makes up the exterior of the device, and may be used for decorative purposes, or simply for further protection, so that the device appears attractive to consumers.

5. The device of claim 1 wherein said material has the additional means of providing protection from debris.

6. The device of claim 1 wherein said plurality of rows would consist of material which has means of providing air flow across the material of claim 1, thereby cooling the heat emitted by motorcycle exhaust.

7. The material of claim 6 wherein said plurality of rows is made of copper.

8. The material of claim 6 wherein said plurality of rows is made of nylon.

9. The material of claim 6 wherein said plurality of rows of claim 6 provides protection to a motorcycle muffler in that, in the event of impact, said rows would crush on impact, rather than damage the muffler.

10. The material of claim 4 wherein said exterior material is attached by glue to the interior material described in claim 1.

11. Thermal tape is applied to the four edges of material of claim 4, with means of preventing fraying and ensuring the longevity of the device.

12. The thermal tape set forth in claim 11 has relatively low thermal conductivity and it will not leave adhesive residue from high temperatures.

13. The material of claim 4 wherein said exterior material is attached to male and female Velcro straps, with means of allowing the materials of claims 1 and 4 to be secured in place and removed as a rider prefers.

14. Installation of the product described in claim 1 is done by cutting two (2) slots, with a household tool, in said material to accommodate the muffler support bracket and wrapping same around the muffler and attaching the lengthwise ends with the claim 13 Velcro straps.

15. The used of the product set forth in claim 1 is not limited to motorcycle mufflers with circular shapes, but it also encompasses use with a multitude of shapes and sizes, such as elliptical shapes, and for mufflers with an approximate average length of 22″ and circumference of 18″.
